(19) United States
(12) Patent Application Publication
(10) Pub. No.: US 2012/0068580 A1
(43) Pub. Date: Mar. 22, 2012

(54) LINEAR DRIVE UNIT

(75) Inventor: Hsien-Mo LIN, Taichung City (TW)

(73) Assignee: Her Yuan Chyun Co., Ltd., Taichung City (TW)

(21) Appl. No.: 12/884,496

(22) Filed: Sep. 17, 2010

(51) Int. Cl. H02K 11/00

(52) U.S. Cl. 310/68 B

(57) ABSTRACT

A linear drive unit having a casing with top, middle and low bodies, a vertical gear, DC motor, shaft and control module. The bodies and DC motor are fitted with an O-seal. The turntable and worm are fixed at end of the shaft. A connection sit is set on the circuit wafer of the control box and has big and small contact strips, so that when the turntable is rotated, I-type conductor contacts the contact strips to generate signal connection for computation of stroke. A drive shaft is driven by the worm to rotate the worm gear cam which has a cam department that pushes L-/R-terminal for a circuit breakage, so that DC motor is stopped to control the threshold. When the cam is rotated, an inspection piece is driven to contact the circuit wafer to inspect the transmission signals, specific position and reset the specified point.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a drive unit, and more particularly to an innovative one which is configured into a linear mechanism.

2. Description of Related Art Including Information Disclosed Under 37 CFR 1.97 and 37 CFR 1.98.

The “linear drive unit” refers to a mechanism that permits a shaft to rotate under the drive of a DC motor and then make the actuator generate linear reciprocating movement. Such a linear drive unit is widely used as a lifter.

Said linear drive unit is structurally configured so that the shaft controller could control the rotation of the shaft and output signals for precise stroke control and automatic reversing movement between two ends.

The sensing structure of typical linear drive unit is generally implemented by a magnetic sensor. Yet, when the shaft is rotated quickly, start delay or even circuit breakage against magnetic sensing may occur due to the magnetic field, leading to poor control quality.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production, development and design of related products.

### BRIEF SUMMARY OF THE INVENTION

Based on the unique configuration wherein the sensing part of the control module is of a contact-type pattern, the present invention could improve greatly the accuracy of stroke control and steering control for the shaft.

As the driving from the shaft to the worm gear cam can be steered through the drive shaft in collaboration with the first worm department of the worm gear cam and the worm of the turntable, this makes it possible to minimize the spare parts, save the assembly space and reduce the cost.

As thrust bearings are assembled adjacently at interior of two ball bearings for the shaft assembly portion of the casing, this could improve axial and radial stability and load strength of the shaft in combination with the load-bearing drive mechanism of the change gear set.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of the assembled linear drive unit of the present invention.

FIG. 2 shows a schematic view of the linear drive unit of the present invention.

FIG. 3 shows a schematic view of the change gear set of the present invention.

FIG. 4 shows an exploded view of the large component of the linear drive unit of the present invention.

FIG. 5 shows an exploded view of the partial component of the linear drive unit of the present invention.

FIG. 6 shows an exploded view of the details of the control module of the present invention.

FIG. 7 shows an exploded view of the large component of the control module of the present invention.

FIG. 8 shows a sectional view of the assembled details of the present invention.

FIG. 9 shows a circuit switching schematic view of the unidirectional connection controller of the present invention.

FIG. 10 shows another circuit switching schematic view of the unidirectional connection controller of the present invention.

### DETAILED DESCRIPTION OF THE INVENTION

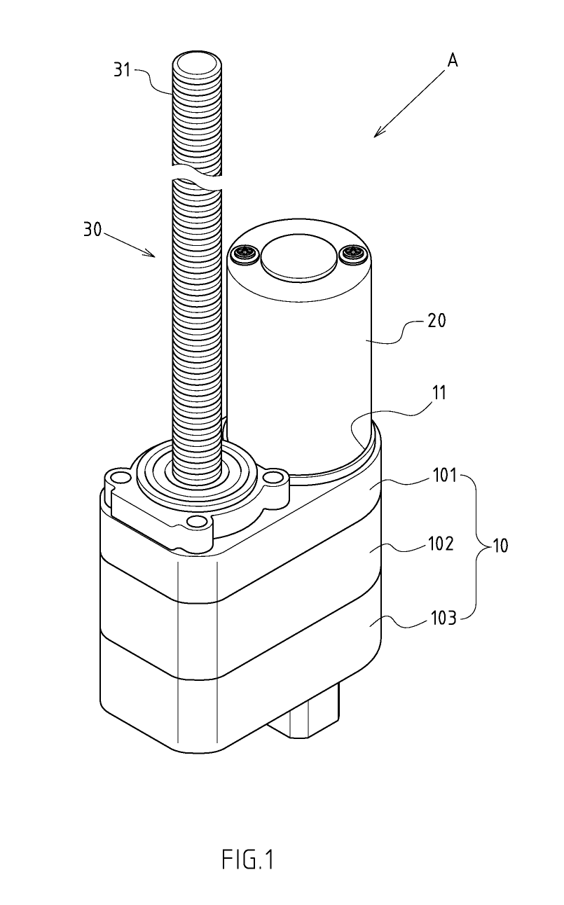

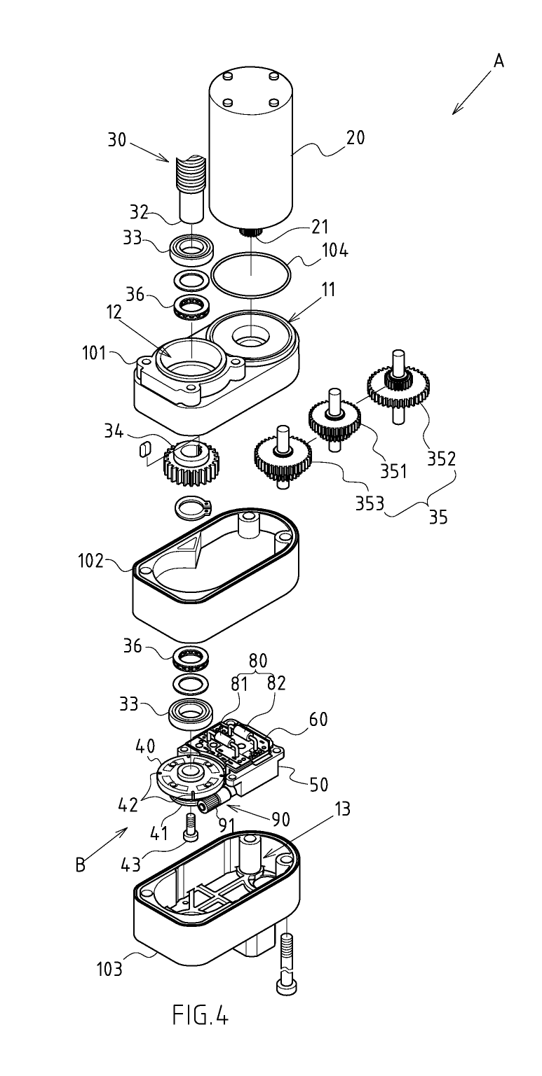

FIGS. 1-6 depict preferred embodiments of a linear drive unit of the present invention, which, however, are provided for only explanatory objective for patent claims. Said linear drive unit A includes a casing 10 with a hollow configuration, having a DC motor assembly portion 11, a shaft assembly portion 12 and a holding space 13. The casing 10 also includes a top body 101, a middle body 102 and a low body 103. Referring to FIG. 5, the top body 101, middle body 102 and low body 103 as well as DC motor assembly portion 11 are fitted with an O-seal 104 for dust-proofing, leakage control, sound insulation and shock absorption as well as for alignment of top and low bodies 101, 103.

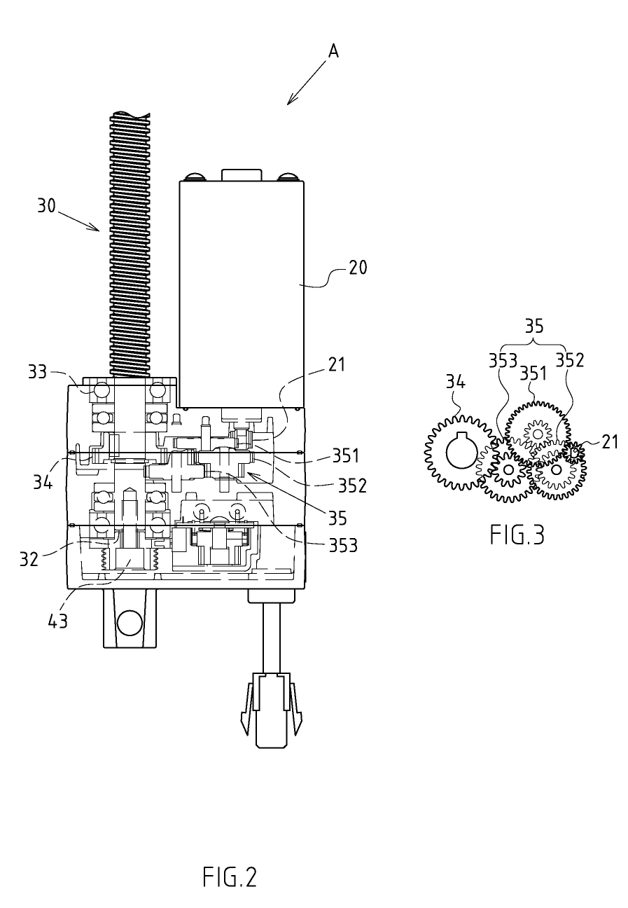

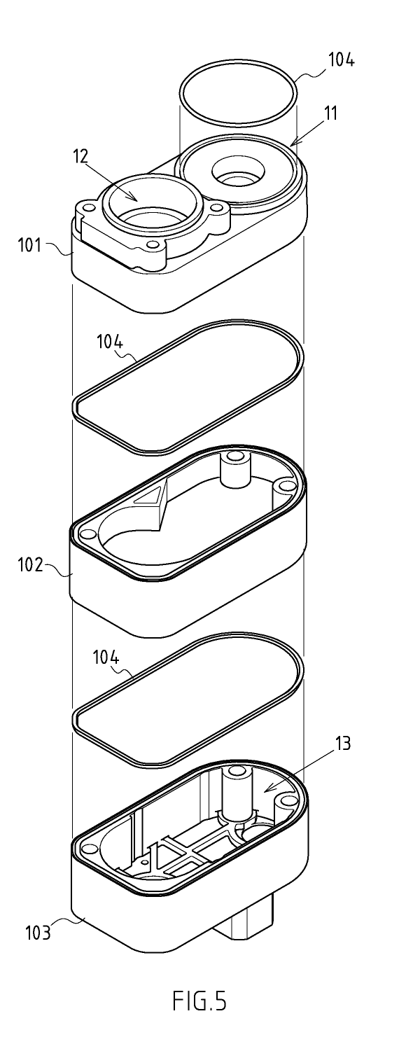

A DC motor 20 is assembled onto the DC motor assembly portion 11 of the casing 10. The DC motor 20 includes a drive gear 21 (marked in FIGS. 2, 4). A shaft 30 is assembled onto the shaft assembly portion 12 of the casing 10 via two ball bearings 33 arranged at interval. The shaft 30 has an extending section 31 and a control module drive end 32 extended into the holding space 13. A shaft gear 34 is positioned close to the control module drive end 32. The shaft gear 34 is connected with the drive gear 21 of DC motor 20 via a change gear set 35, so that the shaft 30 can be driven by DC motor 20. The change gear set 35 includes the first vertical gear 351, second vertical gear 352 and third vertical gear 353 that are meshed together, with their configurations shown in FIGS. 2, 3, 4.

A control module B includes a turntable 40, locked securely via a bolt 43 onto the control module drive end 32 of the shaft 30. One surface of the turntable 40 is fitted with a worm 41, at least an I-type conductor 42 is arranged at periphery of the turntable 40.

A control box 50 is set laterally onto the turntable 40 at interval. A window 51 is set laterally onto the control box 50 correspondingly to the turntable 40.

A circuit wafer 60 is set into control box 50, and laid with a specified point line 61 as well as L-terminal 65 and R-terminal 66 arranged at interval.

A contact signal generator 62 is set onto the circuit wafer 60, and includes a connection sit 621, a large contact strip 622 and a small contact strip 623. Large and small contact strips 622, 623 face the window 51 of the control box 50, so that when the turntable 40 is rotated, the I-type conductor 42 can get in contact with large and small contact strips 622, 623 to generate signal connection. The signal is transmitted to a central processing system of the linear drive unit A for computation.

A left spring terminal 63 and a right spring terminal 64 are protruded at interval onto a side plate of the circuit wafer 60, and kept in contact with L-/R-terminals 65, 66 of the circuit wafer 60. The left and right spring terminals 63, 64 are configured into an elastic L-shaped plate.

A worm gear cam 70 is assembled into the control box 50 in a rotary state. The first end of the worm gear cam 70 is fitted with a first worm department 71, and a cam department 72 is set at one side of the worm gear cam 70. The cam department 72 can push the left spring terminal 63 or right spring terminal 64 with the rotation of the worm gear cam 70, enabling disengagement from the L-terminal 65 or R-terminal 66 in an off state.

A unidirectional connection controller 80 is set onto the circuit wafer 60. When the cam department 72 of said worm gear cam 70 pushes the left spring terminal 63 or right spring terminal 64 to disengage from the L-terminal 65 or R-terminal 66 in an off state, the anode and cathode must be reversed, and then connected through unidirectional connection controller 80 such that DC motor 30 is rotated reversely. Referring to FIG. 4, the unidirectional connection controller 80 of the preferred embodiment has a first diode 81 and a second diode 82, of which the current direction of the first diode 81 and second diode 82 is the same. When the left spring terminal 63 (or right spring terminal 64) is disengaged from L-terminal 65 (or R-terminal 66), reversing of DC motor 20 is made possible only through circuit switching of the first diode 81 or second diode 82.

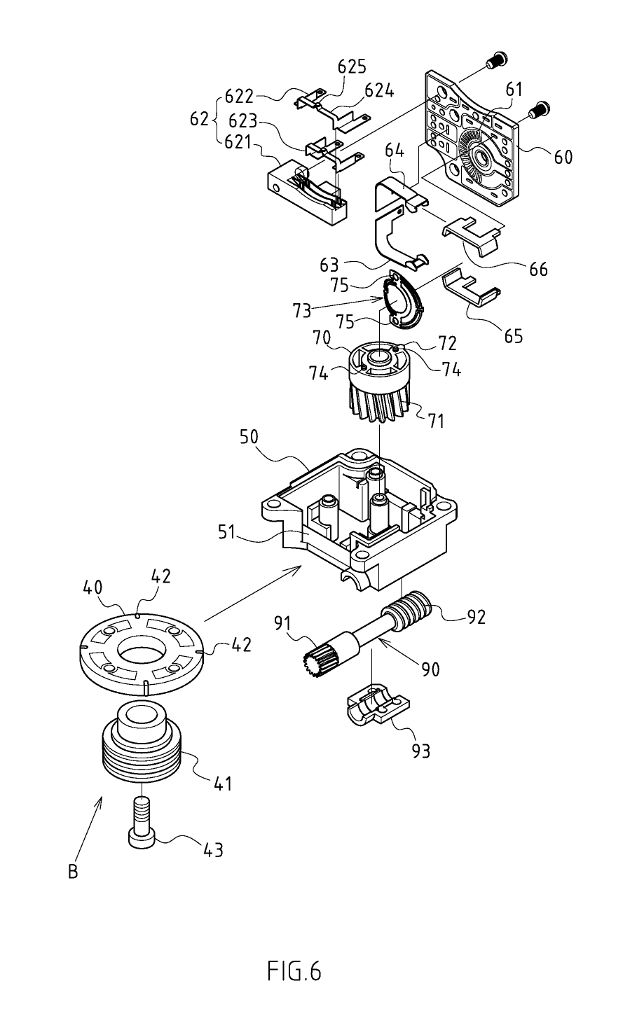

A drive shaft 90 can be assembled between the worm gear cam 70 and turntable 40 through a bearing cover 93 (marked in FIG. 6). The drive shaft 90 has a second worm department 91 and a screw rod department 92. Of which, the second worm department 91 is meshed with the worm 41 of the turntable 40, the screw rod department 92 is meshed with the first worm department 71 of the worm gear cam 70. With this configuration, the driving from the shaft 30 to the worm gear cam 70 can be steered through the drive shaft 90 in collaboration with the first worm department 71 of the worm gear cam 70 and the worm 41 of the turntable 40.

An inspection piece 73 is assembled at one end of the worm gear cam 70, enabling the worm gear cam 70 to drive it and get in contact with the specified point line 61 on the circuit wafer 60 to generate circuit change.

Referring to FIG. 4, the turntable 40 is an insulator, of which I-type conductors 42 are embedded into the periphery of the turntable 40 at four 90°.

Referring to FIG. 6, the large and small contact strips 622, 623 of the contact signal generator 62 include [symbol] shaped elastic section 624, at middle position of which an arched bulge 625 is formed. So I-type conductors 42 of the turntable 40 get in contact with the arched bulge 625 on the elastic section 624 of large and small contact strips 622, 623.

Referring to FIG. 4, two thrust bearings 36 are assembled adjacently at interior of two ball bearings 33 for the shaft assembly portion 12 of the casing 10, thus improving axial and radial stability and load strength of the shaft in combination with the load-bearing drive mechanism of the change gear set 35.

Referring to FIG. 6, two fixed hitches 74 are protruded at interval from the end of the worm gear cam 70. The inspection piece 73 is provided with two locating holes 75 at interval, so that the inspection piece 73 can be sleeved onto the fixed hitches 74 via the locating holes 75.

Based on above-specified structural configuration, the present invention is operated as follows:

Referring to FIG. 4, when the drive gear 21 of DC motor 20 of said linear drive unit A is rotated, the shaft 30 is driven by the change gear set 35 to generate positive and reverse rotation, and then drive a screwing set to generate reciprocating motion.

Referring to FIGS. 4 and 6, the turntable 40 and worm 41 will rotate synchronously with the control module drive end 32 of the shaft 30. In such a case, I-type conductors 42 at periphery of the turntable 40 are rotated to preset angle and then kept in contact with the large and small contact strips 622, 623 of the contact signal generator 62 for an inductive action, helping to generate the signals in response to the rotating stroke of the shaft 30. On the other hand, when the worm 41 is rotated, the drive shaft 90 will be driven to rotate the worm gear cam 70.

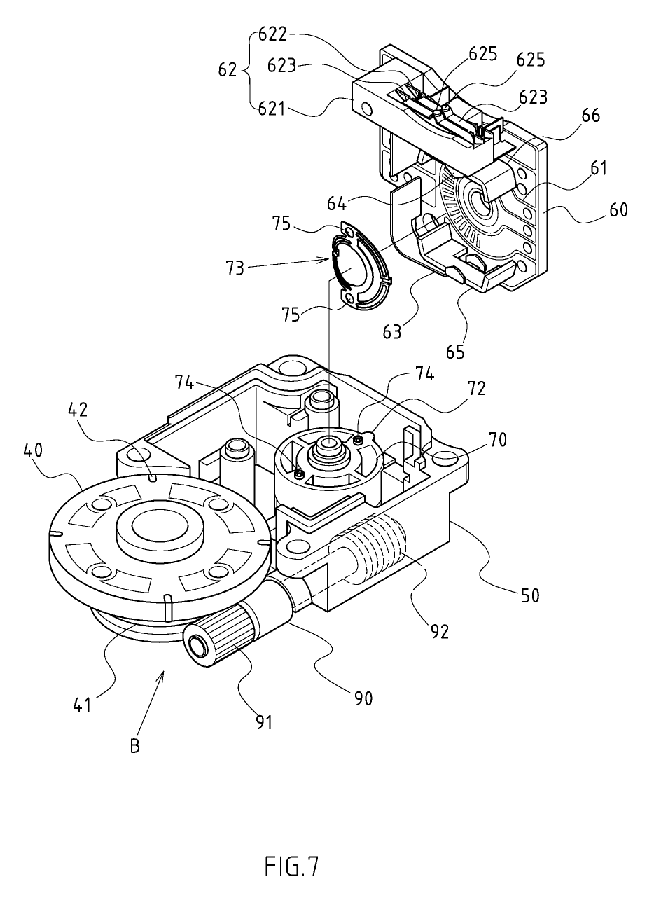

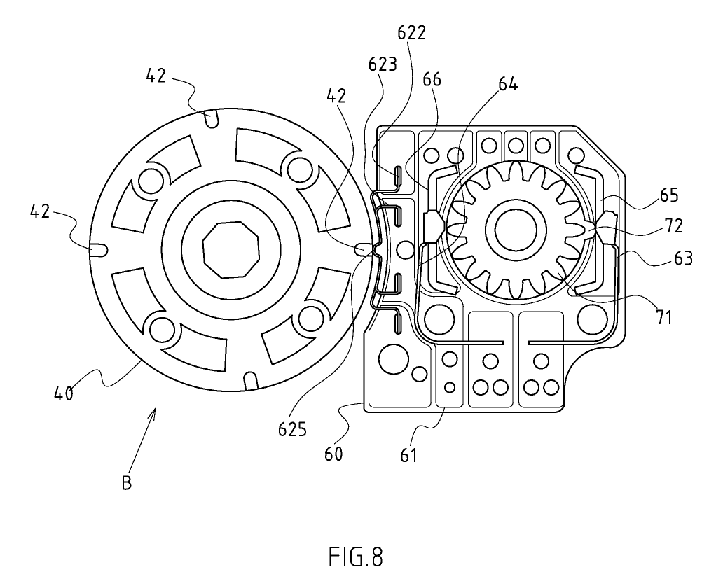

Referring also to FIGS. 7 and 8, with the varying rotation angle of the worm gear cam 70, the cam department 72 will push left spring terminal 63 (or right spring terminal 64) at different sides, making them disengage from the L-terminal 65 (or R-terminal 66) in an off state.

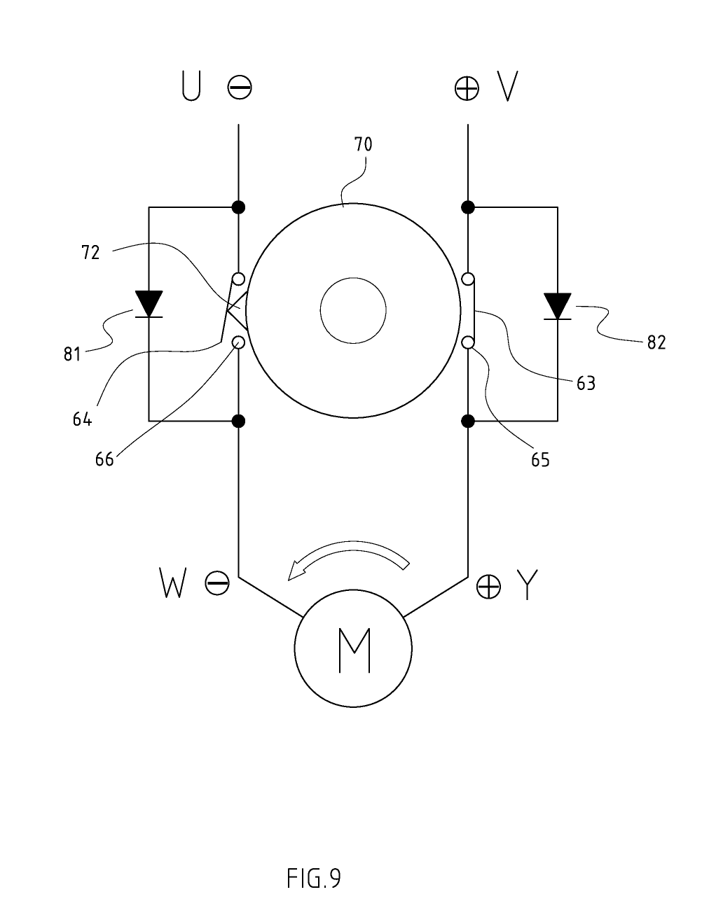

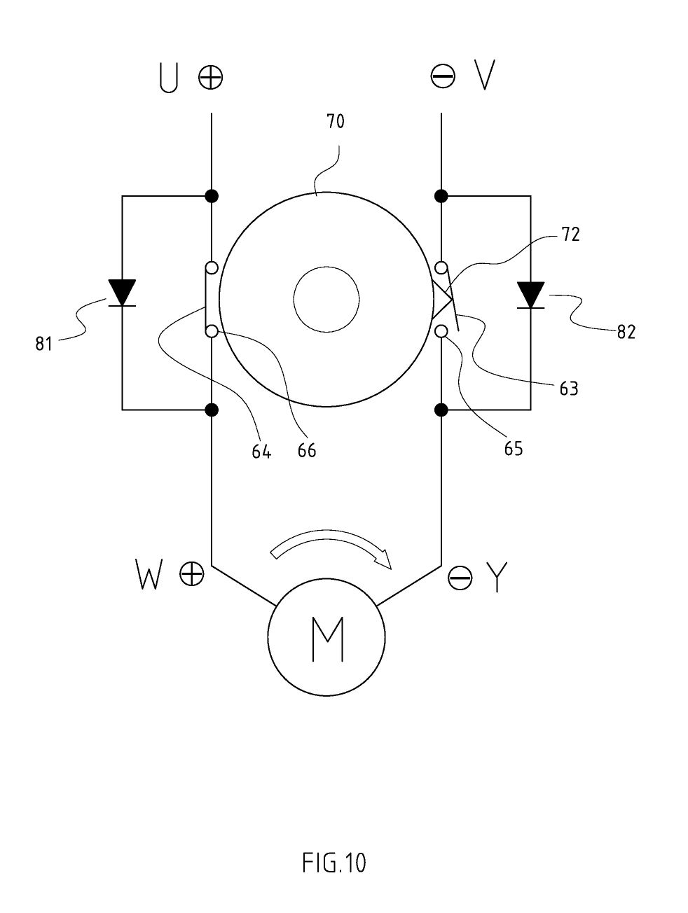

The steering control principle of the unidirectional connection controller 80 is shown in FIG. 9. When the cam department 72 of the worm gear cam 70 is rotated to the corresponding position of the right spring terminal 64, the right spring terminal 64 is pushed by the cam department 72 to disengage from R-terminal 66, so the original circuit is shut off, and DC motor 20 is stopped to avoid overstroke of the shaft 30. Given the cathode of original current, the first diode 81 cannot be connected, leading to complete circuit breakage. Next, CPU senses automatically the disabled state of DC motor, or the anode and cathode are reversed manually for original current (namely, reversing U and V anode and cathode in the figure). Under such conditions, the current can pass through the first diode 81 on the bypass circuit, so reversing rotation of the DC motor 20 is realized, as this case may be when the cam department 72 of the worm gear cam 70 is rotated to the corresponding position of the left spring terminal 63 shown in FIG. 10.

1. A linear drive unit, comprising:
a casing having a DC motor assembly portion, a shaft assembly portion and a holding space; the casing also having an top body, a middle body and a low body; the top body, middle body and low body as well as DC motor assembly portion are fitted with an O-seal;
a DC motor, assembled onto the DC motor assembly portion of the casing; the DC motor having a drive gear;
a shaft, assembled onto the shaft assembly portion of the casing via two ball bearings arranged at interval; the shaft having an extending section and a control module drive end extended into the holding space; a shaft gear is positioned close to the control module drive end; the shaft gear is connected with the drive gear of DC motor via a change gear set, so that the shaft can be driven by DC motor;
a control module, further comprising:
a turntable, locked securely onto the control module drive end of the shaft; one surface of the turntable is fitted with a worm, at least an I-type conductor is arranged at periphery of the turntable; a control box, set laterally onto the turntable at interval; a window is set laterally onto the control box correspondingly to the turntable;
a circuit wafer, set into control box, and laid with a specified point line as well as L-terminal and R-terminal arranged at interval;
a contact signal generator, set onto the circuit wafer, having a connection sit, a large contact strip and a small contact strip; large and small contact strips face the window of the control box, so that when the turntable is rotated, I-type conductor can get in contact with large and small contact strips to generate signal connection;
left and right spring terminals, protruded at interval onto a side plate of the circuit wafer, and kept in contact with L-/R-terminals of the circuit wafer;
a worm gear cam, assembled into the control box in a rotary state; the first end of the worm gear cam is fitted with a first worm department, and a cam department is set at one side of the worm gear cam; the cam department can push the left or right spring terminal with the rotation of the worm gear cam, enabling to disengage from the L-terminal or R-terminal in an off state;
a unidirectional connection controller, set onto the circuit wafer; when the left or right spring terminal is disengaged from the L-terminal or R-terminal in an off state, the anode and cathode must be reversed, and then connected through unidirectional connection controller such that DC motor is rotated reversely; the unidirectional connection controller having a first diode and a second diode, of which the current direction of the first and second diodes is the same;
a drive shaft, which can be assembled between the worm gear cam and turntable; the drive shaft having a second worm department and a screw rod department; of which, the second worm department is meshed with the worm of the turntable, the screw rod department is meshed with the first worm department of the worm gear cam;
an inspection piece, assembled at one end of the worm gear cam, enabling the worm gear cam to drive it and get in contact with the specified point line on the circuit wafer to generate circuit change.

2. The device defined in claim 1, wherein said turntable is an insulator, of which I-type conductors are embedded into the periphery of the turntable at four 90°.

3. The device defined in claim 1, wherein the large and small contact strips of the contact signal generator have [symbol] -shaped elastic section, at middle position of which an arched bulge is formed; so I-type conductors of the turntable get in contact with the arched bulge on the elastic section of large and small contact strips.

4. The device defined in claim 1, wherein thrust bearings are assembled adjacently at interior of two ball bearings for the shaft assembly portion of the casing, thus improving axial and radial stability and load strength of the shaft.
